(19) United States
(12) Patent Application Publication
(10) Pub. No.: US 2015/0175276 A1
(43) Pub. Date: Jun. 25, 2015

(54) DELIVERY PLATFORM FOR UNMANNED AERIAL VEHICLES

(71) Applicant: Kenneth Lee Koster, Spring Lake, MI (US)

(72) Inventor: Kenneth Lee Koster, Spring Lake, MI (US)

(21) Appl. No.: 14/560,821

(22) Filed: Dec. 4, 2014

Related U.S. Application Data
(60) Provisional application No. 61/918,439, filed on Dec. 19, 2013.

(51) Int. Cl. B64F 1/32; B64C 39/02; B64D 1/02

(52) U.S. Cl. CPC B64F 1/32; B64D 1/02; B64C 39/024; B64C 2201/128

(57) ABSTRACT

An unmanned aerial vehicle (UAV) delivery apparatus is provided. The UAV delivery apparatus may include at least a pole and a landing platform. The pole of the present invention may have an extended length with a bottom end and a top end. The bottom end is securable to a surface to support the pole in an upright position. The landing pad of the present invention is attached to the top end of the pole and includes a substantially flat upper surface. The upper surface is sized to receive a package from a UAV.

### CROSS-REFERENCE TO RELATED APPLICATION

This application claims the benefit of priority of U.S. provisional application number 61/918,439, filed Dec. 19, 2013, the contents of which are herein incorporated by reference.

### BACKGROUND OF THE INVENTION

The present invention relates to delivery of packages and, more particularly, to a platform for receiving delivery packages from unmanned aerial vehicles.

An unmanned aerial vehicle (UAV), commonly known as a drone is an aircraft without a human pilot aboard. Amazon® and other retailers are planning to use UAVs to deliver orders. However, the delivery is risky because obstructions may be in the area of the landing or delivery.

As can be seen, there is a need for a delivery platform for drones.

### SUMMARY OF THE INVENTION

In one aspect of the present invention, an unmanned aerial vehicle delivery apparatus comprises: a support structure comprising a bottom end and a top end, wherein the bottom end is securable to a surface to secure the support structure in an upright position; and a landing platform attached to the top end of the support structure and comprising an upper surface sized to receive a package from an unmanned aerial vehicle.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is a perspective view of the present invention demonstrating UAV communication with the present invention and package alignment;

FIG. 3 is a perspective view demonstrating package deposit;

FIG. 4 is a section view of the present invention along line 4-4 in FIG. 2;

FIG. 5 is a section detail view of the present invention along line 5-5 in FIG. 3; and

FIG. 6 is a section detail view of the present invention demonstrating final package placement.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a landing pad or delivery box for an unmanned delivery vehicle (UAV). The present invention may include a landing pad that provides a safe location that may be identified with a Global Position System (GPS) coordinates for deliveries. In certain embodiments, the landing pad may be elevated to allow the unmanned flying vehicle to not interfere with pets, people or other obstacles. In certain embodiments, the landing pad may include a trap door on the top to allow the package being delivered to drop into a secured mail box for safe delivery. The present invention may include a communication beacon between the landing pad and the unmanned flying vehicle to verify the location and delivery. The landing pad may be raised for delivery and lowered to retrieve the package.

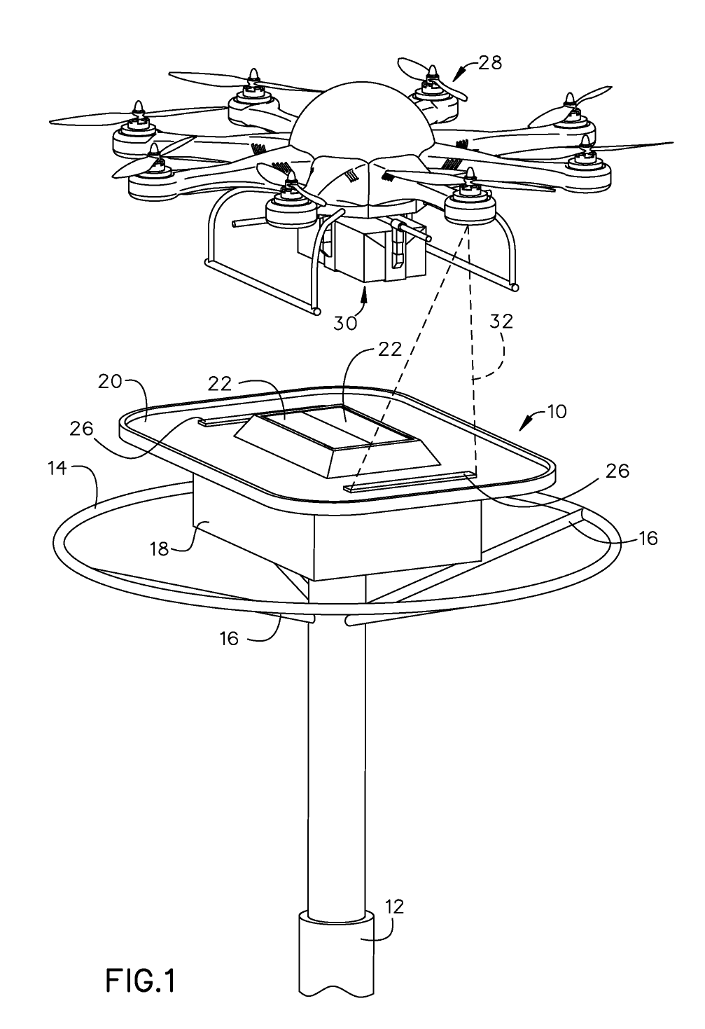

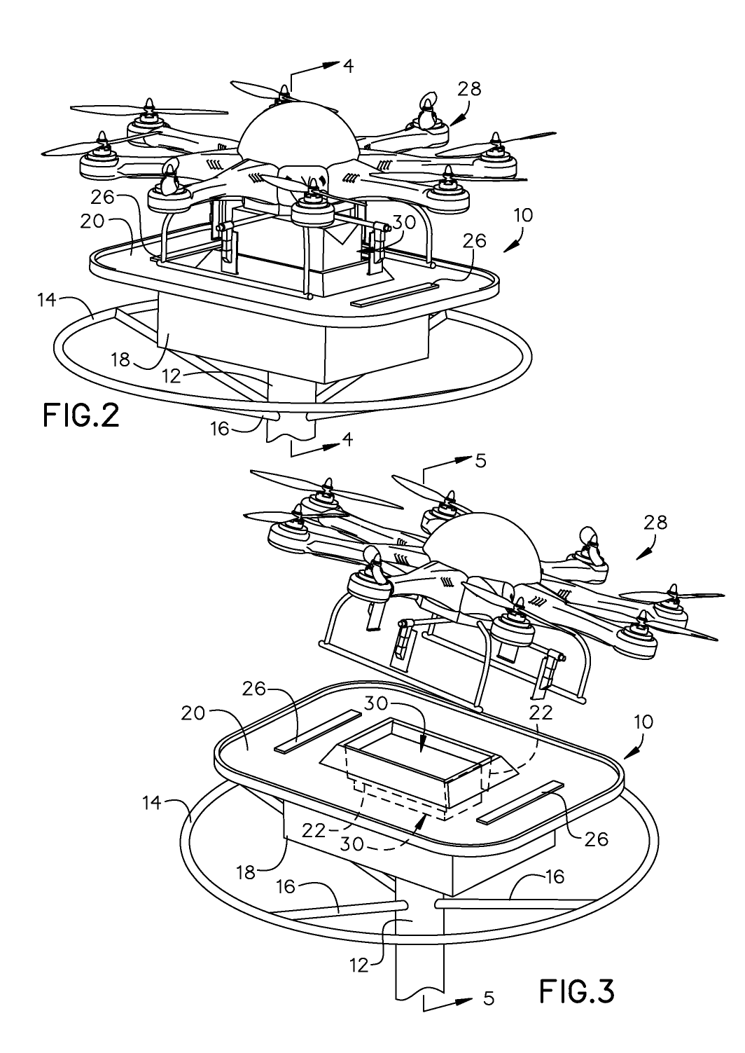

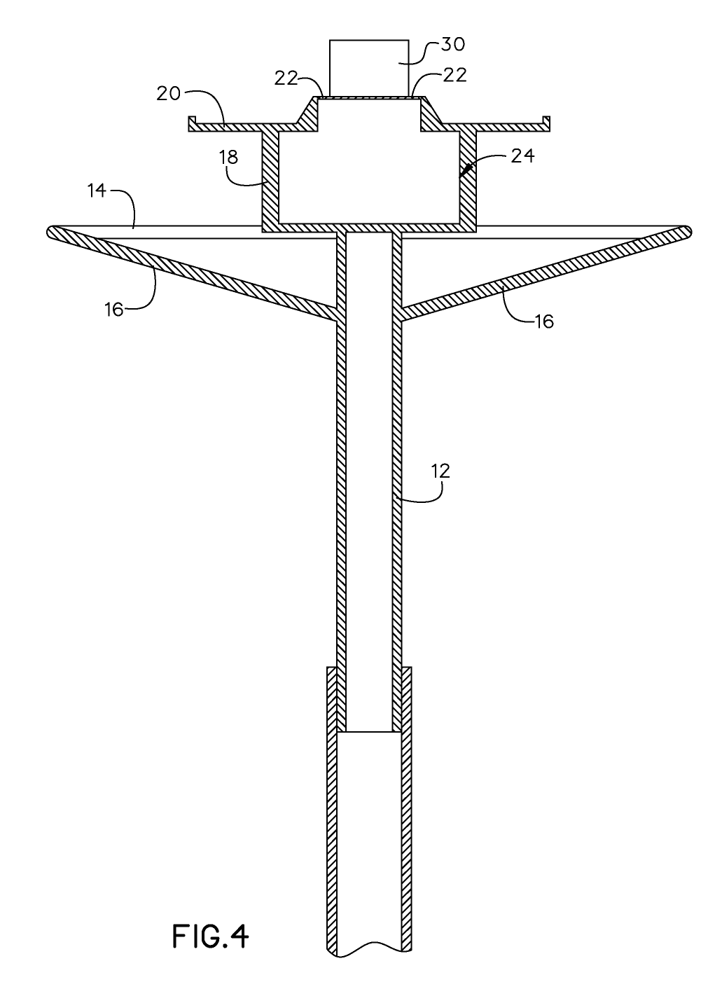

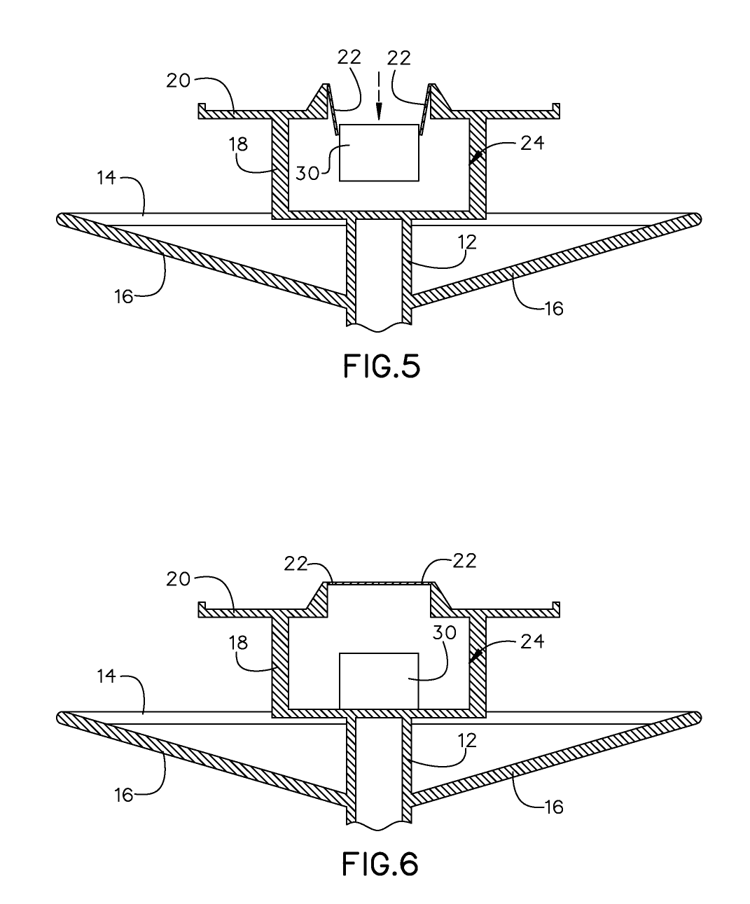

Referring to FIGS. 1 through 6, the present invention includes an unmanned aerial vehicle (UAV) delivery apparatus 10. The UAV delivery apparatus 10 may include a support structure, such as a pole 12, and an elevated landing platform 20. The pole 12 of the present invention may have an extended length with a bottom end and a top end. The bottom end is securable to a surface to support the pole 12 in an upright position. The landing platform 20 of the present invention is attached to the top end of the pole 12 and includes a substantially flat upper surface. The upper surface is sized to receive a package from a UAV 28.

The UAV delivery apparatus 10 may further include a safety barrier 14. The safety barrier 14 may prevent children, dogs, and adults from getting injured or damaging the UAV 28 delivering a package 30. The safety barrier 14 may be attached to the pole 12 below the landing platform 20 by supports 16. The safety barrier 14 includes a greater perimeter or outer edge than the landing platform 20, thereby blocking animals and persons from accidentally reaching into a landing zone. In certain embodiments, the safety barrier 14 may be a ring extending radially from the pole 12 so that the safety barrier 14 does not include pointed edges. The safety barrier 14 may be made of a substantially rigid material with a foam padded covering.

In certain embodiments, the pole 12 of the present invention is extendable and retractable, further preventing potential injury or damage of the UAV 28. In such embodiments, the pole 12 may be extended (i.e. having an increased length) when the UAV 28 is delivering a package, and retracted (i.e. having a decreased length) when a user is retrieving the package 30. In certain embodiments, the pole 12 may be telescopic to facilitate the extended and retracted position. Further, in certain embodiments, the pole 12 may include an actuator operable to extend and retract the pole. The actuator may be activated wirelessly. Therefore, a user may extend and retract the pole 12 at a remote location.

The landing platform 20 of the present invention may further include a security box 18 to retrieve and secure the package 30 within. In such embodiments, a package housing 24 may be formed inside the landing platform 20. An opening is formed on the upper surface of the landing platform 20 leading into the package housing 24. In certain embodiments, the present invention may include pivoting doors 22 attached to the landing platform 20 and positioned to cover the opening. The pivoting doors 22 may be locked in the closed position and unlocked to retrieve the package, thereby creating the security box 18 embedded within the platform 20. In certain embodiments, the security box 18 may be secured to a shoot that directs the package 30 into the home of the user.

In certain embodiments, the present invention may further include a message 26 displayed on the upper surface of the platform 20. The message 26 may be readable by the UAV 28. In certain embodiments, the message 26 may include the location information (Global Position System (GPS) coordinates) of the

UAV delivery apparatus 10 and the status of the delivery order. The UAV 28 may scan 32 the message 26 and thereby upload the information. The UAV 28 may utilize the location information to land on the platform 20 in a proper position. However, in certain embodiments the GPS coordinates may be preprogrammed on the UAV 28 to deliver the package 30 in a precise location on the landing platform 20. The UAV delivery apparatus 10 GPS coordinates may be registered through a smart phone application with the shipper and verified by the UAV that the package is delivered to the correct location.

The UAV delivery apparatus 10 of the present invention may be placed in a yard in an open location to allow the UAV 28 to easily deliver the package 30. The UAV delivery apparatus 10 may also be placed in front of a window, in front of the front door, on a rear deck, on top of the home, and the like. The present invention may be used for any shipment or delivery of a product. It could also be used for returns. By placing your returns on the landing platform 20 the UAV 28 would come and pick it up.

It should be understood, of course, that the foregoing relates to exemplary embodiments of the invention and that modifications may be made without departing from the spirit and scope of the invention as set forth in the following claims.

What is claimed is:

1. An unmanned aerial vehicle delivery apparatus comprising:
a support structure comprising a bottom end and a top end, wherein the bottom end is securable to a surface to secure the support structure in an upright position; and
a landing platform attached to the top end of the support structure and comprising an upper surface sized to receive a package from an unmanned aerial vehicle.

2. The unmanned aerial vehicle delivery apparatus of claim 1, wherein the support structure is a poll.

3. The unmanned aerial vehicle delivery apparatus of claim 2, further comprising a safety barrier attached to the pole below the landing platform and comprising a greater perimeter than a perimeter of the landing platform.

4. The unmanned aerial vehicle delivery apparatus of claim 3, wherein the safety barrier is a ring extending radially from the pole.

5. The unmanned aerial vehicle delivery apparatus of claim 2, wherein the pole is extendable and retractable.

6. The unmanned aerial vehicle delivery apparatus of claim 5, wherein the pole is telescopic.

7. The unmanned aerial vehicle delivery apparatus of claim 5, further comprising an actuator operable to extend and retract the pole.

8. The unmanned aerial vehicle delivery apparatus of claim 1, wherein the landing platform comprises a package housing sized to receive a package, wherein an opening is formed on the upper surface leading into the package housing.

9. The unmanned aerial vehicle delivery apparatus of claim 8, further comprising at least one pivoting door attached to the upper surface and covering the opening.

10. The unmanned aerial vehicle delivery apparatus of claim 9, further comprising a lock securing the at least one pivoting door in a closed position.

11. The unmanned aerial vehicle delivery apparatus of claim 1, further comprising a message displayed on the upper surface of the platform and readable by the unmanned aerial vehicle.
